(19) United States
(12) Patent Application Publication
(10) Pub. No.: US 2008/0191101 A1
(43) Pub. Date: Aug. 14, 2008

(54) Aerofoil Surface for Controlling Spin

(76) Inventors: Geoffrey Hatton, Peterborough (GB); Simon Mcintosh, Cambridge (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/909,500

(22) PCT Filed: Mar. 23, 2006
(86) PCT No.: PCT/GB2006/050067

§ 371 Date: Sep. 24, 2007

(30) Foreign Application Priority Data
Mar. 23, 2005 (GB) 0505959.7

(51) Int. Cl. B64C 39/06; B64C 9/00

(52) U.S. Cl. 244/213

(57) ABSTRACT

The invention concerns craft of the type in which a fan directs a jet of fluid (4) over a curved canopy (1). The canopy (1) is shaped to divert the flow from a radial to an axial direction to produce lift. A problem is that rotation of the fan causes unwanted rotation of the canopy (1). The problem is solved using vanes (6) on the canopy (1) that have an adjustable surface area; and by providing a control system to adjust the effective surface area so as to compensate for the tendency of the rotor to rotate the canopy. The vanes (6) can be designed to slide in and out of the canopy (1) to obtain the required adjustment. In a preferred arrangement the vanes are arranged between upstream and downstream ends of the flow at a position where the effects of changes in swirl angle with varying rotor speed at least partially compensate for consequential changes in the tendancy for the canopy to spin.

This invention relates to a craft designed to move through or on a surface of a fluid. It is believed to be principally of use in relation to airborne craft and missiles but the theory behind the invention is equally applicable for example to submarines.

The invention arose in the design of a craft of the type in which a fan is used to direct a radial jet of air over a curved canopy. The canopy is shaped so as to divert the flow of air from a radial to an axial direction to produce lift. A problem is that the rotation of the fan also tends to cause rotation of the canopy and hence some control system needs to be put in place to prevent such unwanted rotation.

First attempts to deal with this problem involved the use of hinged vanes extending from the surface of the canopy and arranged so that the air flow over them would cause a turning effect in opposition to the unwanted rotation. A hinged flap on each vane allowed the geometry of the vanes to be adjusted for different airflow speeds; and to allow the craft to be deliberately turned when required. However, this solution was found to be unsatisfactory because insufficient adjustment could be obtained by varying the geometry of vanes in this way.

A further complication arose because the flow of air over the canopy was found to have a circumferential component which is different at different positions. This complicated the design and control of the vanes.

According to the invention there is provided a craft designed to move through or on a surface of a fluid comprising means for controlling an aerofoil surface to prevent or control spin of the vehicle, characterised by means for varying the effective aerofoil surface area.

The adjustment of aerofoil surface area can easily be implemented by using vanes which slide in and out of apertures in the hull or canopy. In this way, any desired correcting moment of force can be obtained, ranging from zero, when the vanes are fully retracted, to a maximum value depending only on the length of the vanes i.e. the maximum distance of projection. Furthermore, this adjustment can be achieved without compromising the aerodynamic effectiveness of the vane shape, which can remain fixed at all positions of adjustment. Other possible methods of varying the effective surface area would be to employ hinged vanes which can be swivelled outwardly into a deployed position or withdrawn into the canopy as required. Another possibility would be to use a flexible sheet of material which could be furled or unfurled in a manner similar to a sail on a boat. Yet another approach would be to use structures whose shape can be changed to vary their surface area e.g. by inflation, stretching or compression.

It is preferred to include a control mechanism which controls the amount of aerofoil surface in use as a function of the speed of the jet flow so as to achieve a stable datum condition in which spin does not occur unless introduced deliberately to effect controlled turning of the vehicle.

Where a fan is used to direct a “radial” jet of air over a curved canopy it has been found that the jet flow over the surface of the canopy is not only radial i.e. the air does not flow in imaginary planes passing through the axis of the canopy; but swirls around the canopy shape, intersecting such planes at an angle. This swirl angle diminishes in the downstream direction, i.e. with increasing radius, but increases with increasing fan speed. Thus, the swirl angle at the most downstream point i.e. at the lower edge of the canopy is approximately zero for all fan speeds but, close to the fan, is highly dependant on fan speed.

The inventor has now realised that one can use to advantage the fact that the relationship between fan speed and swirl angle is different at different positions on the canopy. By placing the vanes at appropriate positions between upstream and downstream extremities of the airflow, a “sweet spot” can be found where increasing lift from the vanes with increased fan speed, will match the increased spin effect which needs to be cancelled. Thus, the required adjustment of the vanes can be reduced to a tiny amount, just sufficient to allow for any inaccuracy in the matching referred to above or to turn the craft as a deliberate manoeuvre.

The use of this “sweet spot” is considered to constitute an independent inventive concept and thus, according to a second aspect of this invention, there is provided a craft in which lift is generated by turning a jet of fluid from a radial towards an axial direction and in which the flow swirls circumferentially over a surface of the craft to an extent which diminishes with increasing distance; characterised by at least one aerofoil surface positioned along the flow so that a change in torque caused by a change in fluid speed is at least partially balanced by an opposite change in aerofoil-generated torque caused by a change in swirl angle and hence aerofoil angle of attack.

One way in which the invention may be performed will now be described by way of example with reference to the accompanying drawings in which:

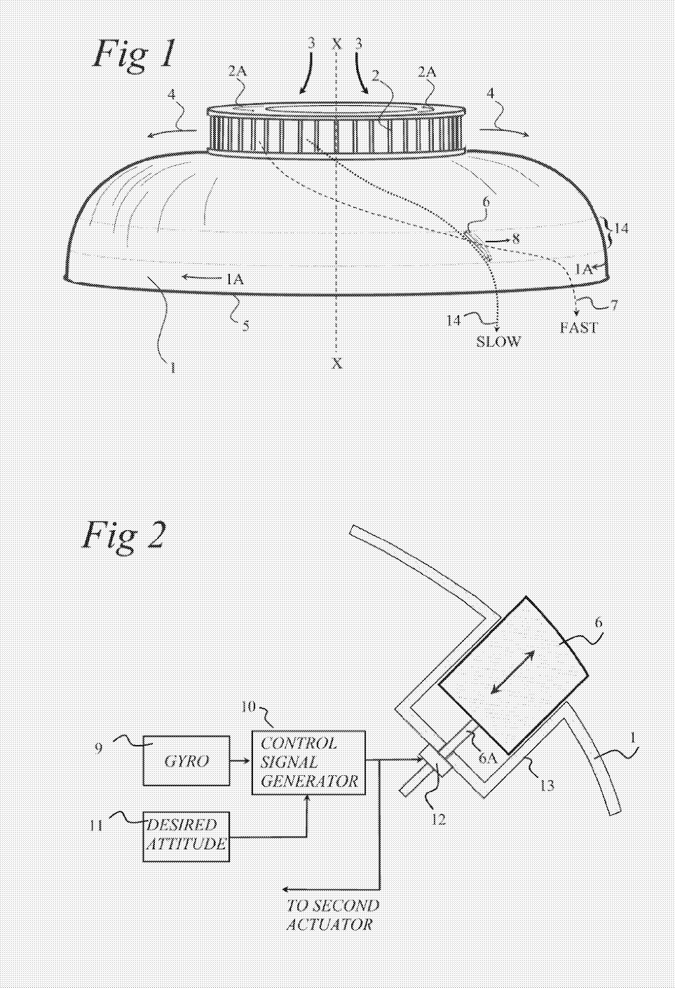

FIG. 1 is a perspective view of a vertical take-off aircraft constructed in accordance with the invention indicating lines 7 and 14 of airflow at different fan speeds, assuming a vane 6 is fully retracted; and

FIG. 2 is a cross section through a control vane of the aircraft shown in FIG. 1.

Referring to FIG. 1, the illustrated vertical take-off aircraft comprises a dome-shaped canopy 1 which is symmetrical about a vertical axis X-X. At the top of the canopy is mounted a radial fan 2 driven at variable speed, in an anticlockwise direction as viewed from above as indicated by arrows 2A. The fan is driven by a motor (not shown) inside the canopy.

Air is drawn into the fan along the axis as indicated by the arrows 3 and is expelled as a jet over the curved surface of the canopy as indicated by arrows 4. The curved surface of the canopy causes the jet to be diverted from a plane of the fan, normal to the axis X-X, towards the axial direction; and the jet finally parts from the canopy surface at its lower edge 5. This diversion of the jet towards the vertical axis generates vertical lift. This effect is known as the Coanda effect.

Because of the rotary action of the fan 2, the air expelled from it has a circumferential velocity component which is greater at greater fan speeds. Measurements have shown that this circumferential component diminishes in a downstream direction so that, at the lower edge 5 of the canopy, the flow direction is close to axial and is relatively independent of fan speed as compared with upstream positions.

Rotation of the fan in the anticlockwise direction causes, by reaction, a corresponding moment of force tending to rotate the canopy in a clockwise direction as indicated by the arrows 1A. This would cause the canopy to spin out of control if remedial action were not taken. In a conventional helicopter this same problem is addressed by employing a tail and a tail rotor. A similar principle could be used in the illustrated craft but this is not preferred because tail rotors are highly vulnerable to damage. Instead, the illustrated craft has two vanes 6 (only one shown) on opposite sides of the canopy. Each of these vanes (there could be more than two in alternative designs) is set at a fixed angle so that a flow of air, as shown by the arrow 7, will create “lift” in a circumferential anticlockwise direction as indicated by arrow 8, opposing the tendency of the canopy to spin in the opposite direction of arrows 1A. The strength of this circumferential lift, caused by the vanes 6, can be adjusted to match the “spin” force which it is desired to cancel, using an adjustment mechanism shown in FIG. 2 as will now be described.

Referring to FIG. 2, an optical or piezoelectric gyroscope 9 generates an output signal indicative of the attitude of rotation of the craft about its axis X-X relative to some datum direction to which it is set on start-up. This is compared at 10 with a direction in which the craft is desired to face as indicated by a steering mechanism 11. The output of comparator 10 is an error signal which is used to control a mechanical actuator 12 (only one shown) attached to the vane 6 via a control rod 6A. Each actuator 12 drives its associated vane 6 in or out of a slot 13 in the canopy with the effect that the canopy is allowed to rotate in the clockwise direction of arrows 1A or is driven in the opposite anticlockwise direction of arrows 8 as appropriate to achieve the attitude defined by control 11. Both vanes are controlled in exactly the same way.

Referring again to FIG. 1, it will be noted that the airflow over the vane 6, as indicated by the arrow 7, defines a relatively large angle of attack with respect to the vane thereby giving a relatively large lift as would be required when the fan is operating at high speed. At a lower speed, the airflow incident on the vane will be more like that shown by the arrow 4, almost parallel to the aerodynamic surfaces of the vane 6, causing relatively little lift. Thus the angle of attack is significantly dependant on fan speed. Had the vanes 6 been positioned close to the lower edge 5 of the canopy, this relationship between angle of attack and fan speed would not be so pronounced because the airflow is approximately axial for all fan speeds. By correctly positioning the vanes in a region 14 carefully selected between the top and bottom of the canopy a relationship between the angle of attack of the air stream and the speed of the fan can be selected so that the spin is almost cancelled automatically for all fan speeds. Thus only a small adjustment of the vanes is required for fine tuning and manoeuvres. This makes the design of the vanes 6 much simpler than would otherwise be necessary.

One of the advantages of a Coanda-effect craft as compared with a conventional helicopter is that, because the fan does not extend beyond laterally beyond the boundaries of the canopy, the craft can safely approach very close to vertical surfaces. In a conventional helicopter, the need for a projecting tail and tail rotor to control spin considerably increases the vulnerability of the craft. By making it possible to control spin effectively in a Coanda Effect craft, without the use of a tail rotor, it is believed that the invention contributes significantly to the advancement of the use of Coanda-effect technology for the design and construction of vertical take-off aircraft.

1. A craft comprising means for generating a jet of fluid and causing it to flow over a curved surface, the curved surface being shaped and positioned so as to cause diversion of the jet from a radial towards an axial direction thereby producing lift, the craft further comprising an aerofoil control surface and means for adjusting the latter to prevent or control spin of the vehicle, characterised by means for varying the effective aerofoil control surface area.

2. A craft according to claim 1 characterised in that the means for varying the aerofoil surface includes a mechanism for moving an aerofoil through an opening in an outer surface of the craft so as to project from it by a greater or lesser amount depending on its position of adjustment..

3. A craft according to claim 2 characterised in that the said aerofoil surface is located at a point between upstream and downstream parts of the said curved surface.

4. A craft according to claim 1 characterised in that the means for varying the effective aerofoil surface is designed or controlled so as to do so as a function of fluid speed over that surface.

5. A craft according to claim 4 characterised in that the means for generating a jet of fluid includes a fan and in that a control system is included for controlling the effective aerol oil surface in dependence on the fan speed.

6. A craft having a central axis and in which lift is generated by turning a jet of fluid from a radial towards an axial direction and in which the flow swirls circumferentially over a surface of the craft to an extent which diminishes with increasing distance; characterised by at least one aerofoil surface positioned along the flow so that a change in torque caused by a change in fluid speed is at least partially balanced by an opposite change in aerofoil-generated torque caused by a change in swirl angle and hence aerofoil angle of attack.

7. A craft according to claim 6 characterised by means for varying the effective area of the aerofoil surface in dependence on fluid speed to correct for any residual imbalance.

8. A craft according to claim 6 characterised by means for generating a jet of fluid and causing it to flow over a curved surface, the curved surface being shaped and positioned so as to cause diversion of the jet from a radial towards an axial direction thereby producing lift, the said aerofoil surface projecting from the said curved surface.

9. A craft according to claim 8 characterised in that the aerofoil surface projects from the curved surface at a position between upstream and downstream parts thereof.

10. A craft designed to move through or on a surface of a fluid comprising means for controlling an aerofoil surface to prevent or control spin of the vehicle, characterised by means for varying the effective aerofoil surface area.
